(19) United States
(12) Patent Application Publication
(10) Pub. No.: US 2023/0196402 A1
(43) Pub. Date: Jun. 22, 2023

(54) SYSTEMS AND METHODS FOR IMPROVING MEMBERSHIP REWARD REDEMPTION OPTIONS

(71) Applicant: Timothy Alan Terwilliger, Wesley Chapel, FL (US)

(72) Inventor: Timothy Alan Terwilliger, Wesley Chapel, FL (US)

(21) Appl. No.: 18/066,413

(22) Filed: Dec. 15, 2022

Related U.S. Application Data
(60) Provisional application No. 63/265,532, filed on Dec. 16, 2021.

(51) Int. Cl. G06Q 30/0207; G06Q 40/08

(52) U.S. Cl. CPC G06Q 30/0236; G06Q 40/08

(57) ABSTRACT

A system for and method of reducing membership rates or specifically related to the healthcare industry, the healthcare premiums, associated with a membership program is detailed herein. The method includes the steps of selecting a membership plan with a set premium, completing one or more qualifying activities, receiving rewards points based on the completion of the one or more qualifying activities, and reducing the premium or membership rate after the rewards points exceed a pre-determined threshold. The qualifying activities can include the purchase of products, referral of new members, and combinations thereof.

### CROSS-REFERENCE TO RELATED APPLICATION

This application claims the benefit of priority of U.S. provisional application No. 63/265,532, filed Dec. 16, 2021, the contents of which are herein incorporated by reference.

### BACKGROUND OF THE INVENTION

The present invention relates to membership programs that can apply to any industry and, more particularly, to systems and methods for healthcare insurance customers to be rewarded for purchases and/or referrals, and to systems and methods for healthcare insurance customers to reduce their healthcare insurance premiums. Beyond the healthcare insurance industry, the systems and methods outlined herein can be used to provide members with more benefits in the redemption of rewards to lower their membership rates.

Healthcare plans provide coverage to enrolled eligible participants in consideration of premiums paid that are used to fund costs incurred by the plan. The term “premium” typically refers to an amount a participant/customer pays every month in consideration for an insurer or health plan providing insurance coverage therefor. The total premium cost is determined in several ways (depending upon the type of plan) but is oftentimes very expensive. At the present, there aren't any effective existing methods to reduce the expense of these insurance plans to customers.

As can be seen, there is a need for a system and method to reduce the above-described premium costs by providing rewards for various purchases and/or referrals made by the customer, which can be redeemed to directly reduce insurance plan premiums. No plans or providers offer customers a way to reduce their costs through the methods detailed herein.

### SUMMARY OF THE INVENTION

In one aspect of the present invention, a method of reducing healthcare premiums associated with a healthcare provider includes the steps of: selecting a healthcare plan with a healthcare premium; completing one or more qualifying activities; receiving rewards points based on the completion of the one or more qualifying activities; and reducing the healthcare premium after the rewards points exceed a pre-determined threshold.

A secondary aspect of the present invention includes a method of rewarding members with lower membership rates of any membership program in any industry. The method includes the steps of selecting a membership level; completing one or more qualifying activities receiving reward points based on the completion of one or more qualifying activities; and selecting an option to redeem reward points to receive a discounted membership rate.

These and other features, aspects and advantages of the present invention will become better understood with reference to the following drawings, description, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a simplified flow chart of a process of an embodiment of the present invention;

FIG. 2 is a detailed flow chart of the embodiment of the present invention; and

FIG. 3 are exemplary tables of redemption options of the embodiment of the present invention.

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details. For the purpose of clarity, technical material that is known in the technical fields related to the present invention has not been described in detail so that the present invention is not unnecessarily obscured.

Broadly, an embodiment of the present invention provides a system for allowing a customer/client to reduce costs of their membership rates. By allowing a user to gain reward points for purchases of select items or through referrals of other customers that sign up for select plans, customers will have the option to apply their reward points to premiums and provide cost savings, or reduced premiums.

The present invention is unique because this method of reducing costs/rates for membership rates does not exist. In order to function, the system of the present invention relies on a method of accumulation of reward points based on purchasing products and/or referring future customers. Subsequent redemption of reward points will provide customers with a method for reducing their membership plan rate. Within the healthcare industry, this novel system allows customers to reduce their healthcare insurance plan premiums. By accumulating reward points from purchasing select products and/or referring future customers that become members, existing members can apply their reward points to lower their premium costs.

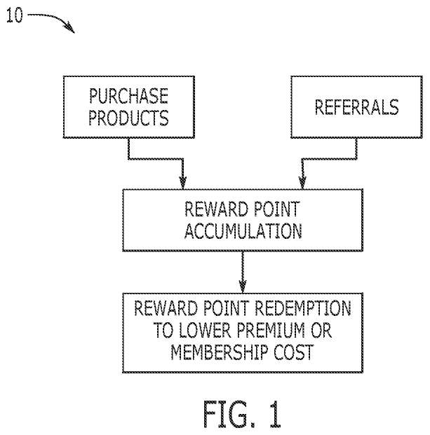

Referring now to FIGS. 1-3, they display the general processes outlining the unique application of referrals to obtain reward points, which can then be redeemed for insurance premium cost reductions.

Referring now to FIG. 1, exemplary steps of a system 10 of the present invention may include the following. First, an existing member of a healthcare insurer purchases eligible products and/or refers potential new customers to become members. When the product purchase is registered in the healthcare insurance system, or the potential new customer becomes a new member, the existing member accumulates reward points. When the reward points accumulate to a pre-determined level (which may vary as established by the insurance carrier, for example), the reward points can be redeemed to affect a reduction of the member's healthcare insurance plan premium cost. As applicable to any industry membership program, when an existing member refers a new potential customer who becomes a member, the initial existing member receives reward points. The reward points can accrue to a level of redemption for set discounts on the membership rate.

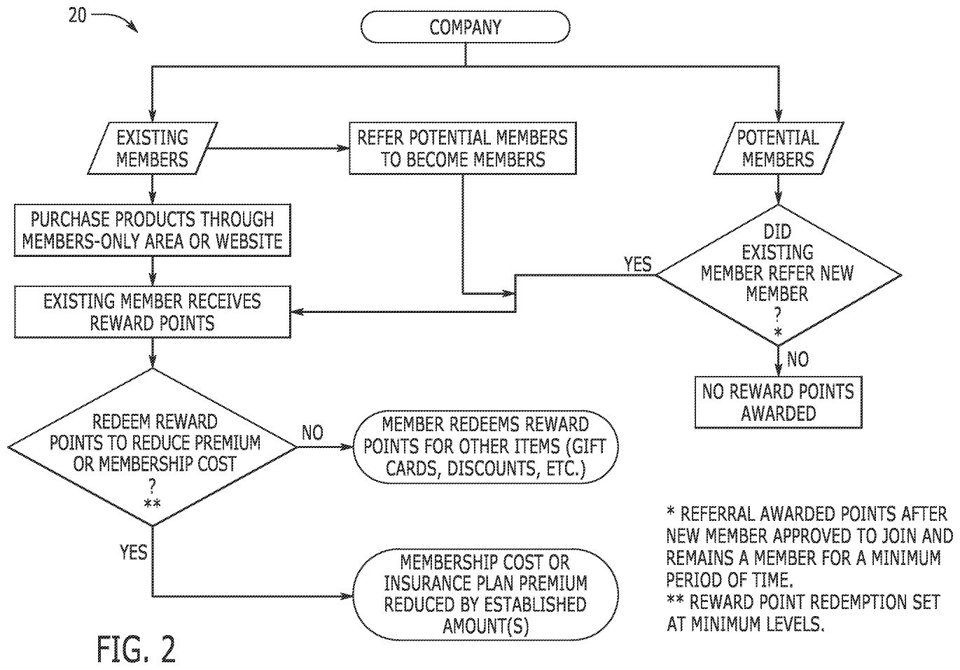

Referring to FIG. 2, an exemplary process logic 20 is outlined to further detail options, decision points and outcomes in accordance with the present invention. It will be appreciated by those with skill in the art that this process may be practiced with modifications and alterations such that the same overall functionality/benefits described herein are achieved. As those with skill in the art will appreciate, certain steps that follow may be computer-implemented. Unconventional technical implementations are specifically referred to below, as appropriate.

The insurance carrier company relies on existing members and potential members to purchase healthcare insurance plans. Each healthcare plan has a set monthly premium paid by the member. Existing members will be able to obtain reward points by purchasing products through the “Members-only” website and/or by referring to new potential members who become members. In some embodiments, to receive the best level of reward points for purchasing products, a user must be a member and purchase through the password-protected secure Members-only website.

When a new potential member becomes a member, there may be a referral from an existing member that factored into the new potential member's decision to become a member (e.g., a “qualifying activity”). When an existing member refers a new potential member who becomes a member, the existing member is rewarded (via rewards points). If a new potential member was not referred by an existing member or a new potential member does not meet the minimum criteria, no reward points are awarded for the new member signing up.

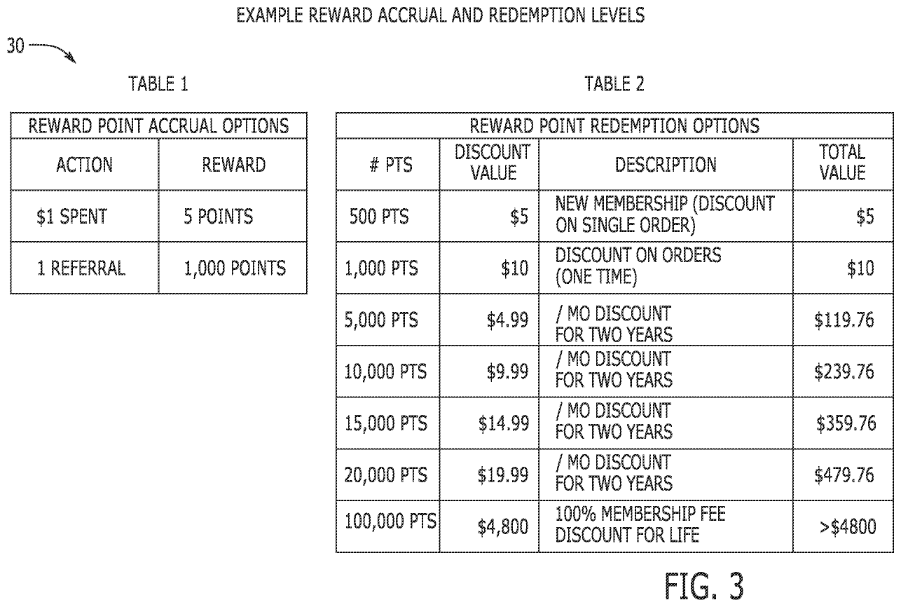

Once the existing member receives reward points, and minimum accumulation criteria are met, the existing member can choose to redeem the points for either a reduced premium amount or other reward options. In certain embodiments, the rewards points are credited automatically to the members accounts in both the purchase and referral scenario. FIG. 3 depicts accrual and redemption levels 30, split into exemplary Tables 1 and 2. Table 1 shows how an existing member may accrue points, and Table 2 shows various ways in which points may be redeemed for a premium or membership rate reduction or discounts.

If the member chooses a reduction in their monthly or annual insurance premium or membership amount, and all criteria are met, the member receives a reduction of their choice. Otherwise, if the member elects to redeem points for other reward options, the member receives other rewards of their choice. By way of example, a member could use 5,000 points to receive a $4.99 per month discount on their membership/premium rate. Of course, these thresholds and rewards levels can be adjusted without departing from the spirit and scope of the present disclosure.

As discussed, if the existing member purchases select products, then they receive reward points. If the existing member refers a potential new customer, and the new customer becomes a member, and the new member meets certain minimum membership criteria, then the existing member receives reward points. If the reward points accumulate to an established level, then the member can redeem the reward points for a reduction of their healthcare insurance plan premium or membership rate.

The accumulation of reward points can occur through purchasing products or through referrals, so either of these elements are optional. However, the redemption of reward points to reduce healthcare insurance plan premium or membership rate cannot happen without accumulation of reward points through purchases and/or referrals. Additional benefits and reward points accumulation and redemption options could be added to improve the system.

In other embodiments of the present invention, the components of reward point accumulation can be interchanged. The reward points can be accumulating through purchasing products or by referring new potential customers that become members, or a combination of both.

In an exemplary embodiment, the system may be used as follows. To solve the problem that this invention solves, a healthcare insurance carrier (or other company) would configure a systemic software application or algorithm to track reward points and allow redemption of the reward points for reductions in healthcare insurance plan premiums or membership rates. It may then be used in accordance with the steps described above.

Industries other than the healthcare insurance industry would be able to use this novel method and system to allow reduced costs using reward points. The present invention is intended to apply primarily to the healthcare insurance industry, but other industries may benefit from the teachings herein.

In an exemplary embodiment, the systemic software may be made or fabricated as follows. To first, an individual must create a program/systemic software to track reward points. The program would need to accommodate a referral code to track the specific source (member) of the referral. The program would also need to allow settings for accumulation of reward points, and redemption of reward points. The program settings would need to align with set levels to allow redemption of reward points that equate to levels of cost reduction of healthcare insurance plan premium or membership rates.

The systemic software of the present invention may include at least one computer with a user interface. The computer may include at least one processing unit coupled to a form of memory. The computer may include, but is not limited to, a microprocessor, a server, a desktop, laptop, and smart device, such as, a tablet and smart phone. The computer includes a program product including a machine-readable program code for causing, when executed, the computer to perform steps (e.g., registering an eligible purchase or referral of an existing member). The program product may include systemic software which may either be loaded onto the computer or accessed by the computer. The loaded systemic software may Include an application on a smart device. The systemic software may be accessed by the computer using a web browser. The computer may access the systemic software via the web browser using the internet, extranet, intranet, host server, Internet cloud and the like. The systemic software will include personal and private security to provide login and unique member identification, consisting of username, password and enhanced security provisions, to ensure individual access, tracking and monitoring of reward point accumulation and redemption. To accommodate the accurate tracking of referrals, a member-unique referral code will be developed, which existing members will be able to share with new potential members to ensure complete connection of the referral back to the existing member.

The present invention has been described in terms of exemplary embodiments solely for the purpose of illustration. Persons skilled in the art will recognize from this description that the invention is not limited to the embodiments described but may be practiced with modifications and alterations limited only by the spirit and scope of the appended claims.

What is claimed is:

1. A method of reducing healthcare premiums associated with a healthcare provider, or membership rates associated with a membership program, the method comprising the steps of:
selecting a membership plan with a set premium;
completing one or more qualifying activities;
receiving rewards points based on the completion of the one or more qualifying activities; and
reducing the membership rate or healthcare premium after the rewards points exceed a pre-determined threshold.

2. The method of claim 1, wherein the healthcare premium may be automatically reduced after the rewards points exceed the pre-determined threshold.

3. The method of claim 1, wherein the one or more qualifying activities comprises a purchase of a product through a membership website or application.

4. The method of claim 1, wherein the one or more qualifying activities comprises a new member signing up via a referral from an existing member.

5. The method of claim 1, wherein said reduction of the membership or the healthcare premium is a one-time reduction.

6. The method of claim 1, wherein said reduction of the membership or the healthcare premium is a recurring monthly or annual reduction for a pre-determined amount of time.

7. The method of claim 1, wherein the reduction of the membership premium is a recurring monthly or annual reduction for a period greater than zero.
